(19) United States
(12) Patent Application Publication
(10) Pub. No.: US 2016/0366162 A1
(43) Pub. Date: Dec. 15, 2016

(54) METHODS CIRCUITS DEVICES ASSEMBLIES SYSTEMS AND FUNCTIONALLY ASSOCIATED COMPUTER EXECUTABLE CODE FOR DETECTING A LINE CONDITION

(71) Applicant: ENERGY RE-CONNECT LTD., Tel Aviv (IL)

(72) Inventor: Roni Herzel, Tel Aviv (IL)

(21) Appl. No.: 15/181,454

(22) Filed: Jun. 14, 2016

Related U.S. Application Data
(63) Continuation-in-part of application No. 15/086,263, filed on Mar. 31, 2016.
Application No. 15/086,263 is a continuation-in-part of application No. 14/664,871, filed on Mar. 22, 2015.
Application No. 14/664,871 is a continuation-in-part of application No. 14/082,152, filed on Nov. 17, 2013, now Pat. No. 9,438,845.
(60) Provisional application No. 61/727,713, filed on Nov. 18, 2012.

(51) Int. Cl. H04L 29/06; G01R 19/25; G01R 27/16

(52) U.S. Cl. CPC H04L 63/1416; G01R 27/16; G01R 19/2506

(57) ABSTRACT

Disclosed is a network appliance, and a system comprising same, for detection of a physical condition of a network cable. The appliance includes one or more line monitoring circuits each of which is adapted to monitor a power barring line or a ground line of the network cable, by measuring one or more electrical parameters of the monitored line. An alert condition detector is adapted to receive from the monitoring circuits, information indicative of measured electrical parameters of the monitored line and to use the received information to identify an alert condition indicative of a physical condition of the network cable.

### RELATED APPLICATIONS

The present Application is a Continuation In Part (CIP) of U.S. patent application Ser. No. 15/086,263, filed Mar. 31, 2016. U.S. patent application Ser. No. 15/086,263 is a Continuation In Part (CIP) of U.S. patent application Ser. No. 14/664,871, filed Mar. 22, 2015. U.S. patent application Ser. No. 14/664,871 is a Continuation In Part (CIP) of U.S. patent application Ser. No. 14/082,152, filed Nov. 17, 2013, which in turn claims priority from U.S. Provisional Patent Application No. 61/727,713, entitled: “A System Apparatus and Device for Facilitating Network Camera Backup and Methods of Operation Thereof”, filed by the inventor of the present Application on Nov. 18, 2012. Each of the aforementioned applications is hereby incorporated by reference into the present application in its entirety.

### FIELD OF THE INVENTION

The present invention generally relates to the fields of Cyber Security and Network Intrusion Detection Systems. More specifically, the present invention relates to methods, circuits, devices, assemblies, systems and functionally associated computer executable code for detecting a line condition.

### BACKGROUND

Edge devices and Security devices, such as surveillance cameras, are mostly located at the physical edges of the network. Edge devices, such as cameras, are installed in places that are often accessible by the public. As these devices are connected to the network, this also increases the risk of unwanted access to the network, wherein people may try to disconnect the security device and connect their own equipment to try to gain access to the network, attach to pass-through equipment, possibly without disrupting operating traffic (i.e. non-intrusive e.g. clamping) to try: a so-called man-in-the-middle attack, tap data lines of network Edge/Security devices sending their data to servers, and/or intrude the cable possibly without disrupting operating traffic.

Video surveillance equipment is increasingly connected across local and global networks. An ever increasing number of network cameras send their data to servers over the physical infrastructure directly or over the Internet. This opens the door to cybercrime.

Accordingly, there remains a need, in the fields of Cyber Security and Network Intrusion Detection Systems, for solutions that may facilitate the existing abilities for detection of line tapping, and/or the detection of other conditions and/or events, associated with a ‘Physical Medium For Transmitting Power and Optionally Data’ (e.g. network line, Power over Ethernet (PoE) line and other type of infrastructures), such as, but not limited to: cyber intrusion events, network control related events, and/or network infrastructure maintenance related events.

### SUMMARY OF INVENTION

The present invention relates to methods, circuits, devices, assemblies, systems and functionally associated computer executable code for detecting a line condition or tap. According to some embodiments, there may be provided one or more line monitoring circuits for detecting indicators of a line tap or a line condition. The one or more circuits may use one or more of the below detection methods.

A line tap or a line condition, in accordance with some embodiments of the present invention, may include, but are not limited to: any type of line intrusion or pre-intrusion (e.g. line isolating layer cutting or needle insertion) activity; any type of line disconnection or pre-disconnection activity; any type of line tapping or pre-tap, ‘listening’, and/or clamping activity; and/or any line impedance and/or or line capacitance affecting factor.

According to some embodiments, a potential line tap, and/or various additional ‘Physical Medium For Transmitting Power and Optionally Data’ (e.g. line) associated events/conditions, may be detected based on Current/Voltage anomalies on the line (Passive Techniques). Current/Voltage anomalies may include, but are not limited to: (1) Detection of a Current surge; (2) Detection of a Current Drop; (3) Detection of a Voltage Surge; (4) Detection of a Voltage Drop; (5) Detection of a Surge followed by drop, followed by stabilized current/voltage; (6) Detection of a specific voltage/current pattern (e.g. a current Surge with a voltage Drop and followed by current drop with voltage rise); (7) Detection of specific line resistance/impedance values and/or specific line resistance/impedance values over time; and/or (8) Detection of line length based on measured resistance (i.e. voltage drop) from current source to current sink.

According to some embodiments, data associated with Current/Voltage anomalies on the line may be further utilized by one or more management algorithm(s) (e.g. a System on Chip (SoC) embedded management algorithm) for: Real time Resources Management, Scenario management, Power management, Dynamic Battery Charge Management (DBCM), Dynamic temperature control, Measurement of energy percentage of a battery substantially instantly, Measuring the length of a physical medium (e.g. line/cable) between a power source or a switch (e.g. a Power over Ethernet (PoE) switch) and the monitoring circuit(s) (e.g. monitoring circuit(s) integrated into an Edge Device Power down backup Unit (PdbU), and/or Cable performance degradation over time alert management (e.g. send alert to installer to replace cable).

According to some embodiments, a potential line tap, and/or various additional Physical Medium For Transmitting Power and Optionally Data′ associated events/conditions, may be detected by utilizing two or more collaborating line monitoring circuits for Initially and then Intermittently performing Channel Sounding to the line.

According to some embodiments, a potential line tap, and/or various additional ‘Physical Medium For Transmitting Power and Optionally Data’ associated events/conditions, may be detected by utilizing a line monitoring circuit for Initially and then Intermittently performing Echo Channel Sounding to the line.

According to some embodiments, upon detection of a potential tap, a circuit according to embodiments may be configured to generate an alert signal. According to further embodiments, the detection circuit may include or be otherwise functionally associated with a communication module adapted to engage in secure communication with a cybersecurity management unit of the network. The Communication module may provide updates to cybersecurity management unit, either based on a schedule or responsive to interrogation/poling and/or some combination of both.

The circuit(s) according to some embodiments of the present invention may be incorporated into a packet switch or router, for example a PoE switch/router. The circuit may also be incorporated into an edge device. The circuit may also be incorporated into a PoE Uninterruptible Power Supply (UPS) located at or in proximity with one or more edge devices. The circuit may also be incorporated into a PoE mid-span power regulator located at or in proximity with one or more edge devices. The circuit may also be incorporated/integrated into a chip or a SoC (e.g. a PdbU SoC).

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram showing an exemplary configuration of a system for line tap detection based on channel current/voltage monitoring, in accordance with some embodiments of the present invention;

FIG. 1B is a flowchart showing the steps of an exemplary process for line condition/tap detection based on channel current/voltage monitoring, in accordance with some embodiments of the present invention;

FIG. 2A is a block diagram showing an exemplary configuration of a system for line condition/tap detection based on channel sounding, in accordance with some embodiments of the present invention;

FIG. 2B is a flowchart showing the steps of an exemplary process for line condition/tap detection based on channel sounding, in accordance with some embodiments of the present invention;

FIG. 3A is a block diagram showing an exemplary configuration of a system for line condition/tap detection based on channel echo sounding, in accordance with some embodiments of the present invention;

FIG. 3B is a flowchart showing the steps of an exemplary process for line condition/tap detection based on channel echo sounding, in accordance with some embodiments of the present invention;

FIGS. 4A-4D are block diagrams showing exemplary possible positions of line-monitoring/tap-detecting/condition-detecting circuits within a simplified network configuration, in accordance with some embodiments of the present invention; and

FIG. 5 is a diagram of an exemplary PdbU SoC incorporating a line Monitoring Circuit(s) for line condition/tap detection, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like. Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

The present invention relates to methods, circuits, devices, assemblies, systems and functionally associated computer executable code for detecting a line condition or tap. According to some embodiments, there may be provided one or more line monitoring circuits for detecting indicators of a line tap or a line condition. The one or more circuits may use one or more of the below detection methods.

At least some of the detection methods below are described in the context of a line tap or a network line tap detection. The described methods, however, may be applicable for detection of various conditions and/or events, associated with any ‘Physical Medium For Transmitting Power and Optionally Data’ (e.g. network line, PoE line), such as, but not limited to: cyber intrusion events, network control related events, and/or network infrastructure degradation and maintenance related events.

According to some embodiments, a potential line tap, and/or various additional ‘Physical Medium For Transmitting Power and Optionally Data’ (e.g. line) associated events/conditions, may be detected by utilizing a line monitoring circuit for detecting Current/Voltage anomalies on the line (may be referred to as: ‘Passive Techniques’). Current/Voltage anomalies may include: (1) Detection of a Current surge; (2) Detection of a Current Drop; (3) Detection of a Voltage Surge; (4) Detection of a Voltage Drop; (5) Detection of a Surge followed by drop, followed by stabilized current/voltage; (6) Detection of a specific voltage/current pattern (e.g. a current Surge with a voltage Drop and followed by current drop with voltage rise); (7) Detection of specific line resistance/impedance values and/or specific line resistance/impedance values over time; and/or (8) Detection of line length based on measured resistance (i.e. voltage drop) from current source to current sink.

According to some embodiments, a potential line tap, and/or various additional ‘Physical Medium For Transmitting Power and Optionally Data’ associated events/conditions, may be detected by utilizing two or more collaborating line monitoring circuits for Initially and then Intermittently performing Channel Sounding to the line. Potential line tap/condition detection may include: (1) Generating a Reference Channel Profile (e.g. attenuation and phase shifts per frequency transfer function) by sounding the channel (e.g. with an impulse) upon initial installation; and (2) Intermittently sounding the channel and comparing new results to the reference channel profile. Potential line tap/condition detection may further include: (3) Notifying if the difference(s), between one or more of the values of the new results and one or more of the reference channel profile values, are greater than a given predefined or dynamically adjusted threshold; or, if the difference(s), between one or more of the values of the new results and one or more of the reference channel profile values, match a given predefined or dynamically adjusted ‘potential line tap/condition indicative differences profile’.

According to some embodiments, a potential line tap, and/or various additional ‘Physical Medium For Transmitting Power and Optionally Data’ (e.g. line) associated events/conditions, may be detected by utilizing a line monitoring circuit for Initially and then Intermittently performing Echo Channel Sounding to the line. Potential line tap/condition detection may include: (1) Generating a Reference Channel Echo Profile (e.g. attenuation and phase shifts per frequency transfer function) by echo sounding the channel (e.g. with an impulse) upon initial installation; and (2) Intermittently echo sounding the channel and comparing new results to the reference channel echo profile. Potential line tap/condition detection may further include: (3) Notifying if the difference(s), between one or more of the values of the new results and one or more of the reference channel echo profile values, are greater than a given predefined or dynamically adjusted threshold; or, if the difference(s), between one or more of the values of the new results and one or more of the reference channel echo profile values, match a given predefined or dynamically adjusted ‘potential line tap/condition indicative differences profile’.

According to some embodiments, upon detection of a potential tap/condition, a circuit according to embodiments may be configured to generate an alert signal. According to further embodiments, the detection circuit may include or be otherwise functionally associated with a communication module adapted to engage in secure communication with a cybersecurity management unit of the network. The Communication module may provide updates to cybersecurity management unit, either based on a schedule or responsive to interrogation/poling and/or some combination of both.

The circuit(s) according to some embodiments of the present invention may be incorporated into a packet switch or router, for example a PoE switch/router. The circuit may also be incorporated into an edge device. The circuit may also be incorporated into a PoE UPS located at or in proximity with one or more edge devices. The circuit may also be incorporated into a PoE mid-span power regulator located at or in proximity with one or more edge devices.

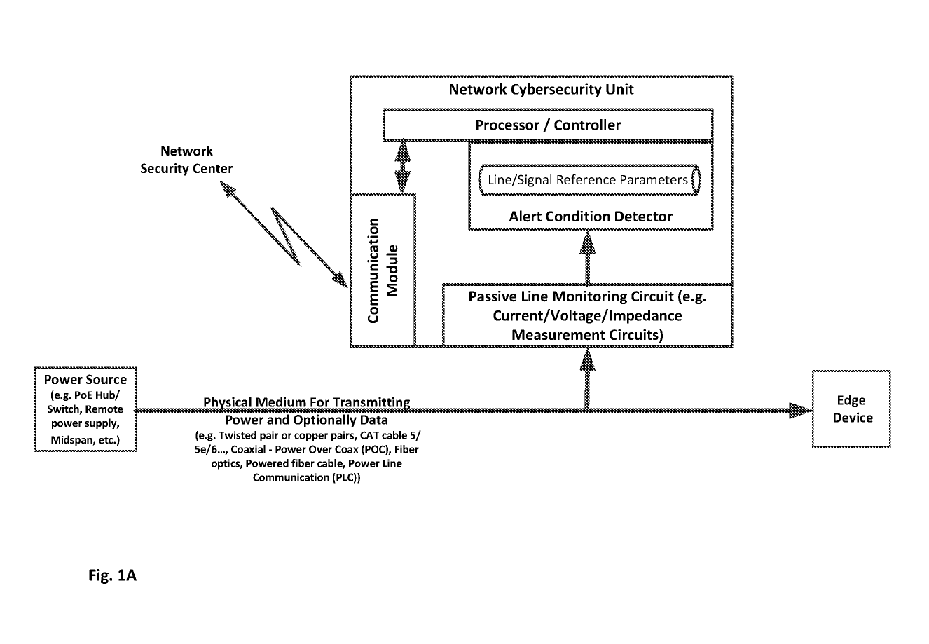

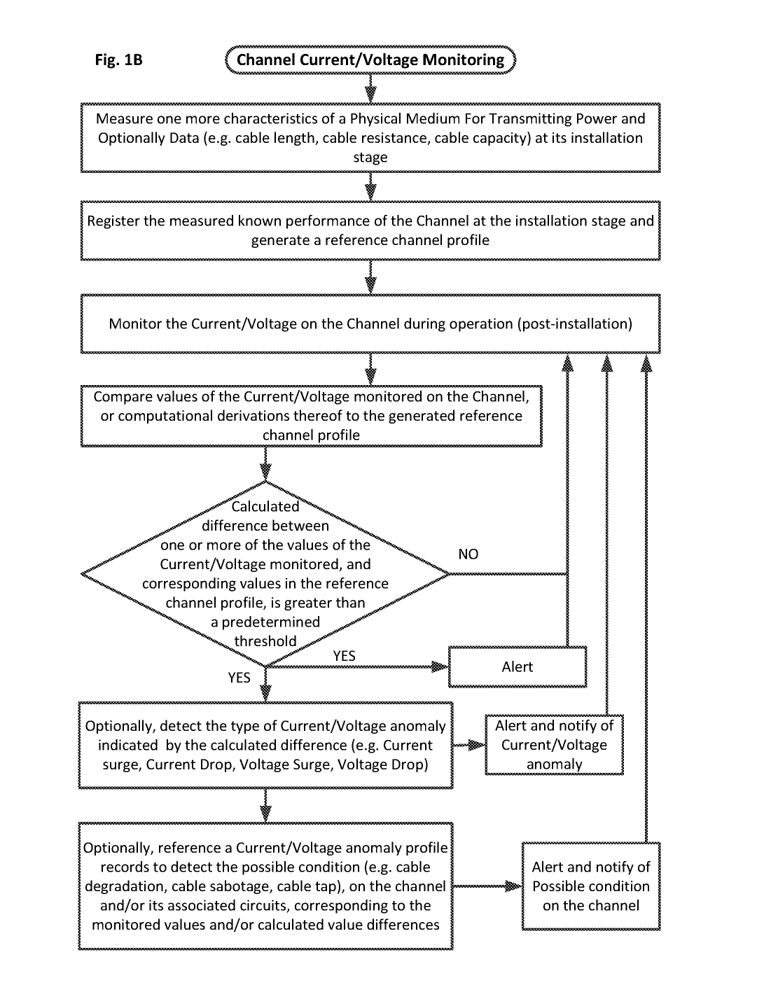

In FIG. 1A there is shown a block diagram of an exemplary configuration of a system for line tap/condition detection based on channel current/voltage monitoring, in accordance with some embodiments of the present invention.

The Line Monitoring Circuit (e.g. Current/Voltage Monitoring Circuits) of the Network Cybersecurity Unit shown, monitors the Physical Medium For Transmitting Power and Optionally Data between the Power Source and the Edge Device. The Alert Condition Detector shown, compares Current/Voltage/Other monitored values of the channel, received from the Line Monitoring Circuit, to Line/Signal Reference Parameters of the channel (e.g. made by a Reference Channel Profile Generator based on Installation Stage Channel Measurements/Performance). Based on the results of the comparison, the Alert Condition Detector determines whether a Current/Voltage anomaly has occurred and notifies the Processor/Controller if such has been detected. The Processor/Controller may directly trigger an Alert System and/or update a Network Security Center through its included/integrated or functionally associated Communication Module.

The Processor/Controller may provide updates based on a schedule or responsive to interrogation/poling and/or some combination of both. Updates communication may be over a secured/encrypted connection.

In FIG. 1B there is shown a flowchart of the steps of an exemplary process for line tap/condition detection based on channel current/voltage monitoring, in accordance with some embodiments of the present invention.

Shown process steps for line detection include: (1) Measure one more characteristics of a Physical Medium For Transmitting Power and Optionally Data (e.g. cable length, cable resistance, cable capacity) at its installation stage; (2) Register the measured known performance of the Channel at the installation stage and generate a reference channel profile; (3) Monitor the Current/Voltage on the Channel during operation (post-installation); (4) Compare values of the Current/Voltage monitored on the Channel to the generated reference channel profile; (5) If calculated difference between one or more of the values of the Current/Voltage monitored, and corresponding values in the reference channel profile, is greater than a predetermined threshold issue an alert and return to step 3; else, return to step 3 without issuing an alert; Optionally (6) Detect the type of Current/Voltage anomaly indicated by the calculated difference (e.g. Current surge, Current Drop, Voltage Surge, Voltage Drop), alert and notify of Current/Voltage anomaly and return to step 3; and Optionally (7) Reference a Current/Voltage anomaly profile records to detect the possible condition (e.g. cable degradation, cable sabotage, cable tap), on the channel and/or its associated circuits, corresponding to the monitored values and/or calculated value differences, alert and notify of possible condition on the channel and return to step 3.

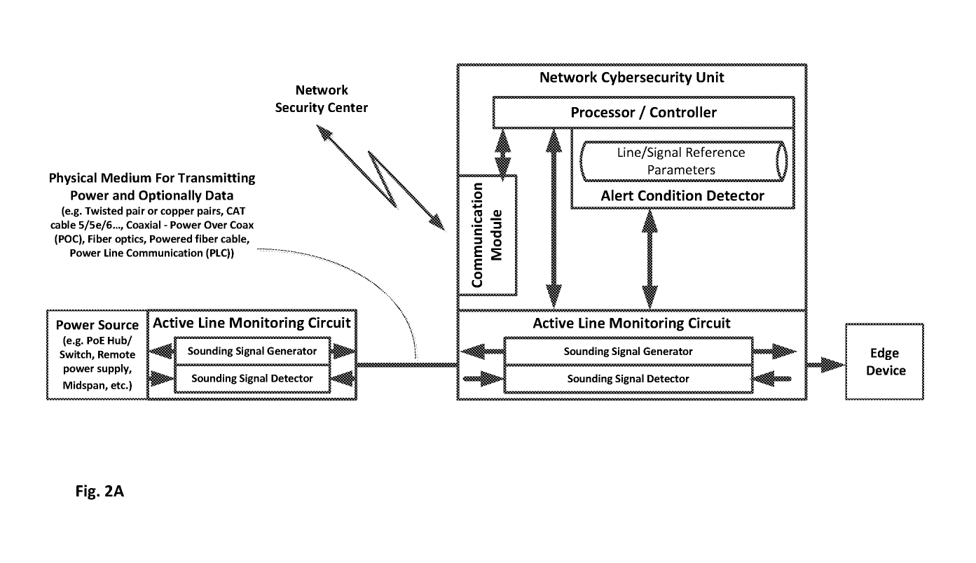

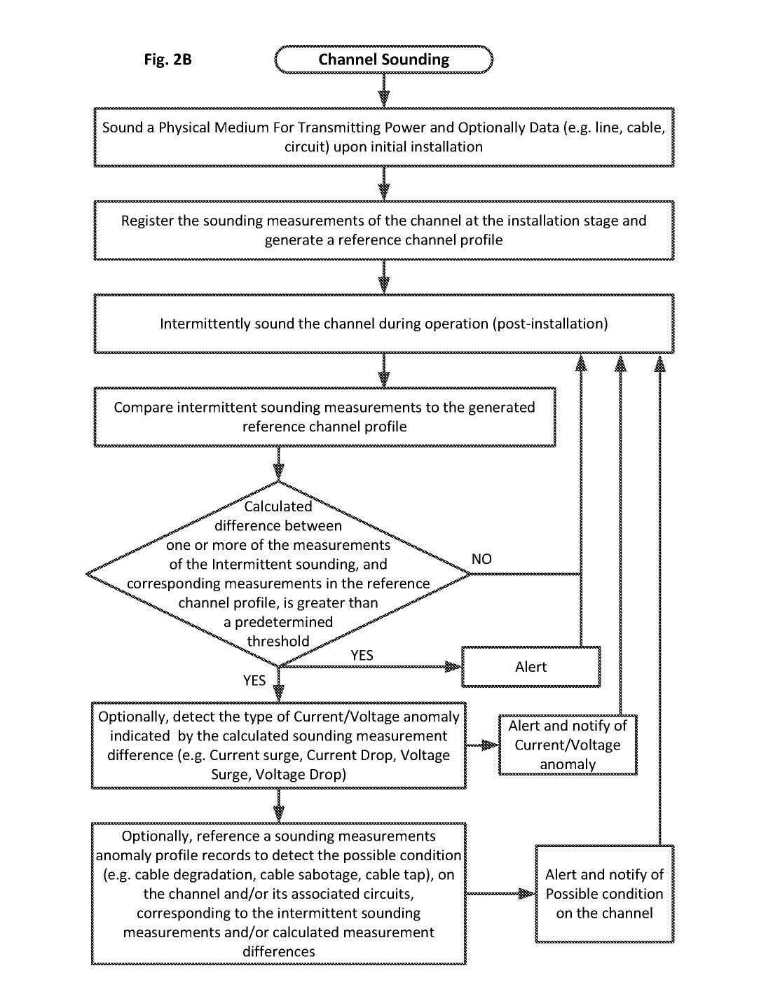

In FIG. 2A there is shown a block diagram of an exemplary configuration of a system for line tap/condition detection based on channel sounding, in accordance with some embodiments of the present invention.

The Line Monitoring Circuits of the Network Cybersecurity Unit shown include: a Sounding Signal Generator for Sounding the Channel and a Sounding Signal Detector for Measurement of the Sounding Signals received on the other/opposite side of the Physical Medium For Transmitting Power and Optionally Data between the Power Source and the Edge Device. The Alert Condition Detector compares intermittently monitored channel sounding values, received from the Sounding Signal Detector, to Line/Signal Reference Parameters of the channel (e.g. made by a Reference Channel Profile Generator based on one or more initial channel sounding(s) made). Based on the results of the comparison, the Alert Condition Detector determines whether a channel sounding anomaly has occurred and notifies the Processor/Controller if such has been detected. The Processor/Controller may directly trigger an Alert System and/or update a Network Security Center through its included/integrated or functionally associated Communication Module.

The Processor/Controller may provide updates based on a schedule or responsive to interrogation/poling and/or some combination of both. Updates communication may be over a secured/encrypted connection.

In FIG. 2B there is shown a flowchart of the steps of an exemplary process for line tap/condition detection based on channel sounding, in accordance with some embodiments of the present invention.

Shown process steps for line detection include: (1) Sound a Physical Medium For Transmitting Power and Optionally Data (e.g. line, cable, circuit) upon initial installation; (2) Register the sounding measurements of the channel at the installation stage and generate a reference channel profile; (3) Intermittently sound the channel during operation (post-installation); (4) Compare intermittent sounding measurements to the generated reference channel profile; (5) If calculated difference between one or more of the measurements of the Intermittent sounding, and corresponding measurements in the reference channel profile, is greater than a predetermined threshold issue an alert and return to step 3; else, return to step 3 without issuing an alert; Optionally (6) Detect the type of Current/Voltage anomaly indicated by the calculated sounding measurement difference (e.g. Current surge, Current Drop, Voltage Surge, Voltage Drop), alert and notify of Current/Voltage anomaly and return to step 3; and Optionally (7) reference a sounding measurements anomaly profile records to detect the possible condition (e.g. cable degradation, cable sabotage, cable tap), on the channel and/or its associated circuits, corresponding to the intermittent sounding measurements and/or calculated measurement differences, alert and notify of possible condition on the channel and return to step 3.

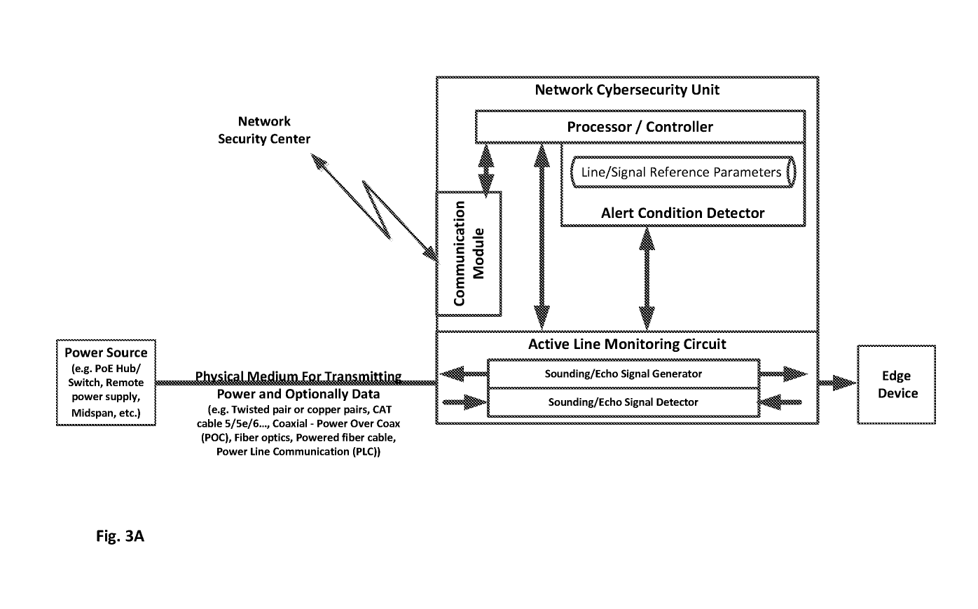

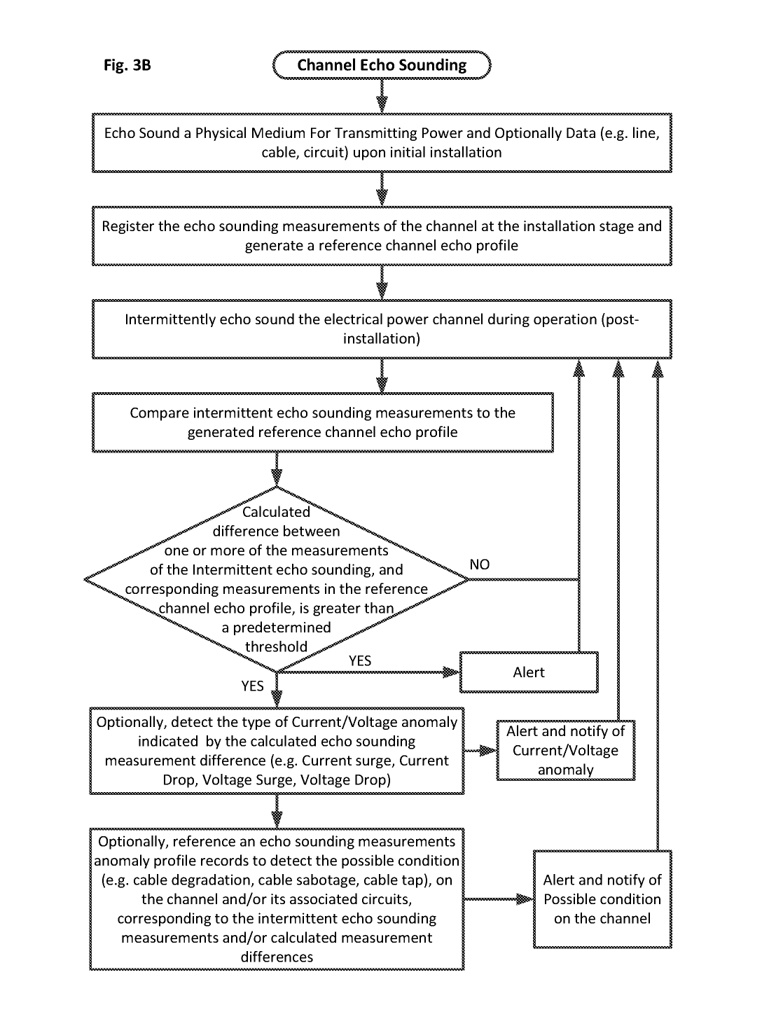

In FIG. 3A there is shown a block diagram of an exemplary configuration of a system for line tap/condition detection based on channel echo sounding, in accordance with some embodiments of the present invention.

The Line Monitoring Circuits of the Network Cybersecurity Unit shown include: a Sounding/Echo Signal Generator for Echo Sounding the Channel and a Sounding/Echo Signal Detector for measurement of the Echo Sounding Signals received back from the Physical Medium For Transmitting Power and Optionally Data between the Power Source and the Edge Device. The Alert Condition Detector compares intermittently monitored channel echo sounding values, received from the Sounding Signal Detector, to Line/Signal Reference Parameters of the channel (e.g. made by a Reference Channel Echo Profile Generator based on one or more initial channel echo sounding(s) made). Based on the results of the comparison, the Alert Condition Detector determines whether a channel echo sounding anomaly has occurred and notifies the Processor/Controller if such has been detected. The Processor/Controller may directly trigger an Alert System and/or update a Network Security Center through its included/integrated or functionally associated Communication Module.

The Processor/Controller may provide updates based on a schedule or responsive to interrogation/poling and/or some combination of both. Updates communication may be over a secured/encrypted connection.

In FIG. 3B there is shown a flowchart of the steps of an exemplary process for line tap/condition detection based on channel echo sounding, in accordance with some embodiments of the present invention.

Shown process steps for line detection include: (1) Echo Sound a Physical Medium For Transmitting Power and Optionally Data (e.g. line, cable, circuit) upon initial installation; (2) Register the echo sounding measurements of the channel at the installation stage and generate a reference channel echo profile; (3) Intermittently echo sound the channel during operation (post-installation); (4) Compare intermittent echo sounding measurements to the generated reference channel echo profile; (5) If calculated difference between one or more of the measurements of the Intermittent echo sounding, and corresponding measurements in the reference channel echo profile, is greater than a predetermined threshold issue an alert and return to step 3; else, return to step 3 without issuing an alert; Optionally (6) Detect the type of Current/Voltage anomaly indicated by the calculated echo sounding measurement difference (e.g. Current surge, Current Drop, Voltage Surge, Voltage Drop), alert and notify of Current/Voltage anomaly and return to step 3; and Optionally (7) reference an echo sounding measurements anomaly profile records to detect the possible condition (e.g. cable degradation, cable sabotage, cable tap), on the channel and/or its associated circuits, corresponding to the intermittent echo sounding measurements and/or calculated measurement differences, alert and notify of possible condition on the channel and return to step 3.

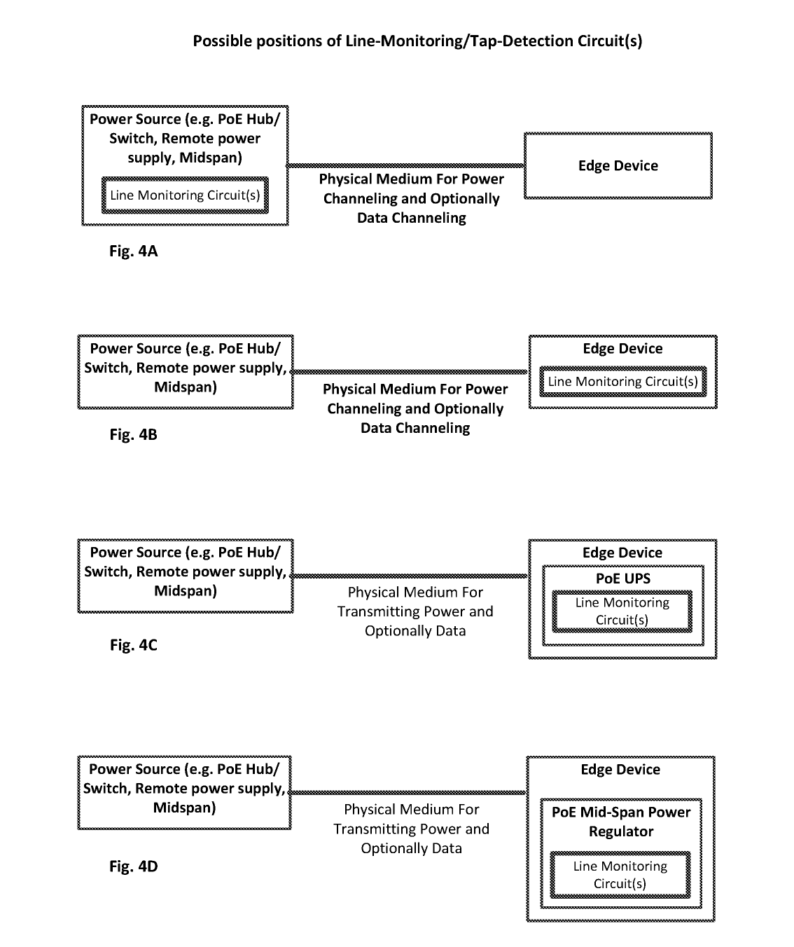

In FIGS. 4A-4D there are shown block diagrams of exemplary possible positions of line-monitoring/tap-detecting/condition-detecting circuits within a simplified network configuration, in accordance with some embodiments of the present invention.

In the figures, Edge Devices are shown connected to a Hub/Switch/Router (e.g. PoE Switch) over a Physical Medium For Transmitting Power and Optionally Data. Line Monitoring Circuit(s) are shown incorporated into the following exemplary positions: into the power source or a packet switch or router (4A), into an edge device (4B), into a PoE UPS incorporated into or located at or in proximity with an edge device (4C), and into a PoE mid-span power regulator incorporated into or located at or in proximity with an edge device (4D).

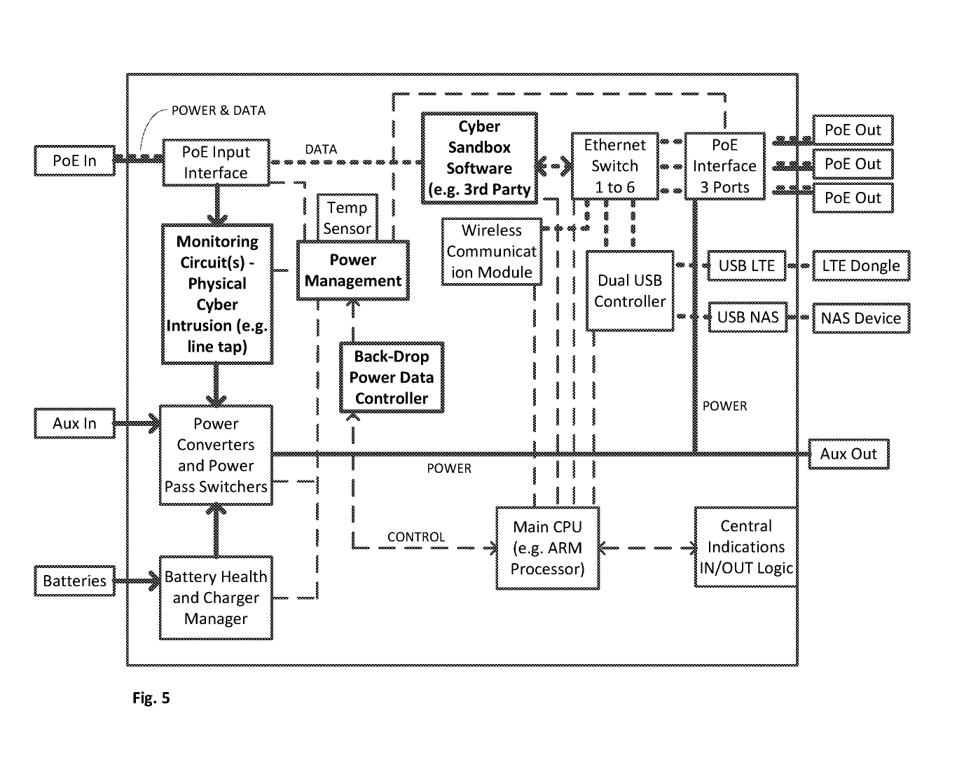

In FIG. 5 there is shown a diagram of an exemplary PdbU SoC incorporating a line Monitoring Circuit(s) for line condition (e.g. Cable tamper) detection, in accordance with some embodiments of the present invention. The shown SoC includes Line Monitoring Circuits connected to a Power Management Component of the SoC. The Power Management Component dynamically routes power to customer loads according to available power (e.g. cable length, Aux in, charge state) choosing most efficient route combined with customer preferences. The Power Management Component, based on line monitored values received from the Line Monitoring Circuits and/or based on additional values it derives from the monitored values, detects potential line conditions/taps and accordingly generates/issues/communicates an alert/alert-signal.

According to some embodiments, the Power Management Component, based on line monitored values received from the Line Monitoring Circuits and/or based on additional values it derives from the monitored values and/or based on data associated with Current/Voltage anomalies detected on the line, may be further utilized by one or more management algorithm(s) (e.g. a System on Chip (SoC) embedded management algorithm) for: Real time Resources Management, Scenario management, Power management, Dynamic Battery Charge Management (DBCM), Dynamic temperature control, Measurement of energy percentage of a battery substantially instantly, Measuring the length of a physical medium (e.g. line/cable) between a power source or a switch (e.g. a Power over Ethernet (PoE) switch) and the monitoring circuit(s) (e.g. monitoring circuit(s) integrated into an Edge Device Power down backup Unit (PdbU), and/or Cable performance degradation over time alert management (e.g. send alert to installer to replace cable).

The shown SoC includes a Back-Drop Power Data Controller for implementing a continuous power communication protocol, on top of the PoE standard. The continuous power communication protocol may: form a first, Physical Cyber Intrusion, protection layer for cable temper detection; form a second, Cyber Sandbox Software (e.g. 3^{rd} party) based, protection layer acting as a gate keeper against malware attempts to penetrate the network through its edge devices; dynamically route power to customer loads according to available power (e.g. cable length, Aux in, charge state) choosing most efficient route combined with customer preferences; manage, or interface with, battery health schemes and charger operation, by charging the battery according to: available power (e.g. cable length, customer loads), battery/other-SoC-component(s) temperature, and/or the battery charging status or ‘battery available power’.

According to some embodiments, some or all of the Back-Drop Power Data Controller and/or the continuous power communication protocol functionalities may be fully or partially executed by, or in cooperation with, the Power Management Component.

The shown SoC further includes: PoE in, Auxiliary in power, and Battery in power ports; a PoE Input Interface for splitting the PoE line to separate power and data channels; Power Converters and Power Pass Switchers; and a Battery Health and Charger Manager for charging the shown batteries according to available power (cable length, customer Loads) and to provide temperature and batteries status.

The shown Main CPU (e.g. ARM Processor) of the SoC is connected to: the Power Management Component, an IN/OUT Logic; a Wireless Communication Module (e.g. for communicating line condition/tap alerts); a Cyber Sandbox Software Module (e.g. 3^{rd} Party Software) for providing inherent gate keeping against mal attempts to penetrate the network through its edge devices; a 1 to 6 Ethernet Switch connected to a 3 Port PoE Interface for uniting separate power and data channels into a PoE line, and 3 Port PoE Interface connected to 3 PoE out ports. The shown Main CPU (e.g. ARM Processor) of the SoC is further connected to a Dual USB Controller connected to both a Cellular (e.g. Long Term Evolution LTE) USB and a USB Network Attached Storage (NAS); the Cellular (e.g. Long Term Evolution LTE) USB and the USB Network Attached Storage (NAS) are shown respectively connected to an external Cellular (e.g. LTE) Dongle and an external NAS Device. Further shown is a Temperature Sensor for measuring temperature of the electric components (e.g. Power Management Component).

According to some embodiments of the present invention, a network appliance for detection of a physical condition of a network cable, may comprise: one or more line monitoring circuits each of which is adapted to monitor a power barring line or a ground line of the network cable, by measuring one or more electrical parameters of the monitored line; and an alert condition detector adapted to receive from said monitoring circuits information indicative of measured electrical parameters of the monitored line and to use the received information to identify an alert condition indicative of a physical condition of the network cable.

According to some embodiments, the monitoring of electrical parameters may be passive monitoring. According to some embodiments, the measured electrical parameter may be the impedance of the monitored line. According to some embodiments, a length of the monitored line may be estimated based on the measured impedance. According to some embodiments, the measured electrical parameter may be a voltage signal. According to some embodiments, a cable tap may be estimated based on the measured voltage signal. According to some embodiments, the measured electrical parameter may be a current signal. According to some embodiments, a cable tap may be estimated based on the measured current signal. According to some embodiments, the measured electrical parameter may be a shape of a reference signal generated by a functionally associated reference signal generator also connected to the cable.

According to some embodiments, the monitoring of electrical parameters may be active monitoring including the introduction of signals to the monitored line. According to some embodiments, the one or more line monitoring circuits may further comprise a sounding signal generator for transmitting a Sounding Signal to a corresponding receiver on the other side of the line. According to some embodiments, the one or more line monitoring circuits may further comprise: an echo sounding signal generator for transmitting an Echo Sounding Signal into the line; and an echo sounding signal detector for measuring one or more electrical parameters associated with the transmitted Echo Sounding Signal, on the monitored line.

According to some embodiments, the appliance may further comprise a controller, functionally associated with the alert condition detector and a communication module, for engaging in secure communication with a security center or unit of the network. According to some embodiments, the controller may provide updates to the security center or unit based on a schedule. According to some embodiments, the controller may provide updates to the security center or unit responsive to interrogation/poling. The controller may provide updates to the security center or unit based on a combination of a schedule and responsive to interrogation/poling. According to some embodiments, the controller may provide updates to the security center or unit, upon the alert condition detector identifying an alert condition indicative of a physical condition of the network cable. According to some embodiments, the controller may provide updates to the security center or unit, upon the alert condition detector identifying an alert condition indicative of an intrusion to the network cable.

According to some embodiments of the present invention, a system for network cable monitoring, may comprise: a network security center for issuing a network condition alert based on received updates; and one or more network appliances for detection of a physical condition of a network cable, each of the appliances comprising: one or more line monitoring circuits each of which is adapted to monitor a power barring line or a ground line of the network cable, by measuring one or more electrical parameters of the monitored line; an alert condition detector adapted to receive from the monitoring circuits information indicative of measured electrical parameters of the monitored line and to use the received information to identify an alert condition indicative of a physical condition of the network cable; and a controller, functionally associated with the alert condition detector and a communication module, for engaging in secure communication with, and providing updates of one or more physical conditions of the network cable to the network security center.

According to some embodiments, the monitoring of electrical parameters may be passive monitoring. According to some embodiments, the monitoring of electrical parameters may be active monitoring including the introduction of signals to the monitored line. According to some embodiments, the controller may provide updates to the security center based on a schedule. According to some embodiments, the controller may provide updates to the security center responsive to interrogation/poling. According to some embodiments, the controller may provide updates to the security center based on a combination of a schedule and responsive to interrogation/poling. According to some embodiments, the controller may provide updates to the security center, upon the alert condition detector identifying an alert condition indicative of a physical condition of the network cable.

According to some embodiments of the present invention, a system on Chip (SoC) for detection of a physical condition of a network cable, may comprising: one or more line monitoring circuits each of which is adapted to monitor a power barring line or a ground line of the network cable, by measuring one or more electrical parameters of the monitored line; and an alert condition detector adapted to receive from the monitoring circuits information indicative of measured electrical parameters of the monitored line and to use the received information to identify an alert condition indicative of a physical condition of the network cable.

According to some embodiments, the monitoring of electrical parameters may be passive monitoring. According to some embodiments, the measured electrical parameter may be impedance of the monitored line. According to some embodiments, the length of the monitored line may be estimated based on the measured impedance. According to some embodiments, the measured electrical parameter may be a voltage signal. According to some embodiments, a cable tap may be estimated based on the measured voltage signal. According to some embodiments, the measured electrical parameter may be a current signal. According to some embodiments, According to some embodiments, a cable tap may be estimated based on the measured current signal. According to some embodiments, the measured electrical parameter may be a shape of a reference signal generated by a functionally associated reference signal generator also connected to the cable.

According to some embodiments, the monitoring of electrical parameters may be active monitoring including the introduction of signals to the monitored line. According to some embodiments, the one or more line monitoring circuits may further comprise a sounding signal generator for transmitting a Sounding Signal to a corresponding receiver on the other side of the line. According to some embodiments, the one or more line monitoring circuits may further comprise: an echo sounding signal generator for transmitting an Echo Sounding Signal into the line; and an echo sounding signal detector for measuring one or more electrical parameters associated with the transmitted Echo Sounding Signal, on the monitored line.

According to some embodiments, the SoC may further comprise a controller, functionally associated with the alert condition detector and a communication module, for engaging in secure communication with a security center or unit of the network. According to some embodiments, the controller may provide updates to the security center or unit based on a schedule. According to some embodiments, the controller may provide updates to the security center or unit responsive to interrogation/poling. According to some embodiments, the controller may provide updates to the security center or unit based on a combination of a schedule and responsive to interrogation/poling. According to some embodiments, the controller may provide updates to the security center or unit, upon the alert condition detector identifying an alert condition indicative of a physical condition of the network cable.

According to some embodiments, the SoC may be electrically adapted for connection to a generic network appliance. According to some embodiments, the generic network appliance may be selected from the group consisting of: edge devices, IP cameras, routers and/or switches. According to some embodiments, the SoC may be electrically integrated to a generic network appliance. According to some embodiments, the generic network appliance may be selected from the group consisting of: edge devices, IP cameras, routers and/or switches. According to some embodiments, the SoC may be electrically integrated to a network security appliance, and the network security appliance may be electrically adapted for connection or integration to a generic network appliance. According to some embodiments, the SoC may be electrically integrated to a network Power down back Up (PdbU) appliance, and the network PdbU appliance may be electrically adapted for connection or integration to a generic network appliance. According to some embodiments, the SoC may be electrically integrated to a network Uninterruptible Power Supply (UPS) appliance, and the network UPS appliance may be electrically adapted for connection or integration to a generic network appliance. According to some embodiments, the SoC may be electrically integrated to a network power source.

According to some embodiments, the network cable, on which detection of a physical condition is performed—by the appliance, the system and/or the SoC—may be a Power over Ethernet (PoE) cable.

The processes and displays presented herein are not inherently related to any particular computer, device, system or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A network appliance for detection of a physical condition of a network cable, said appliance comprising:
one or more line monitoring circuits each of which is adapted to monitor a power barring line or a ground line of the network cable, by measuring one or more electrical parameters of the monitored line; and
an alert condition detector adapted to receive from said monitoring circuits information indicative of measured electrical parameters of the monitored line and to use the received information to identify an alert condition indicative of a physical condition of the network cable.

2. The appliance according to claim 1, wherein the monitoring of electrical parameters is passive monitoring.

3. The appliance according to claim 2, wherein the measured electrical parameter is impedance of the monitored line.

4. The appliance according to claim 3, wherein a length of the monitored line is estimated based on the measured impedance.

5. The appliance according to claim 2, wherein the measured electrical parameter is a voltage signal.

6. The appliance according to claim 5, wherein a cable tap is estimated based on the measured voltage signal.

7. The appliance according to claim 2, wherein the measured electrical parameter is a current signal.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A system for network cable monitoring, said system comprising:
a network security center for issuing a network condition alert based on received updates; and
one or more network appliances for detection of a physical condition of a network cable, each of said appliances comprising:
one or more line monitoring circuits each of which is adapted to monitor a power barring line or a ground line of the network cable, by measuring one or more electrical parameters of the monitored line;
an alert condition detector adapted to receive from said monitoring circuits information indicative of measured electrical parameters of the monitored line and to use the received information to identify an alert condition indicative of a physical condition of the network cable; and
a controller, functionally associated with said alert condition detector and a communication module, for engaging in secure communication with, and providing updates of one or more physical conditions of the network cable to said network security center.

20. The system according to claim 19, wherein the monitoring of electrical parameters is passive monitoring.

21. The system according to claim 19, wherein the monitoring of electrical parameters is active monitoring including the introduction of signals to the monitored line.

22. The system according to claim 19 wherein said controller provides updates to the security center based on a schedule.

23. The system according to claim 19 wherein said controller provides updates to the security center responsive to interrogation/poling.

24. The system according to claim 19 wherein said controller provides updates to the security center based on a combination of a schedule and responsive to interrogation/poling.

25. The system according to claim 19 wherein said controller provides updates to the security center upon said alert condition detector identifying an alert condition indicative of a physical condition of the network cable on a schedule.

26. A System on Chip (SoC) for detection of a physical condition of a network cable, said SoC comparing:
one or more line monitoring circuits each of which is adapted to monitor a power barring line or a ground line of the network cable, by measuring one or more electrical parameters of the monitored line; and
an alert condition detector adapted to receive from said monitoring circuits information indicative of measured electrical parameters of the monitored line and to use the received information to identify an alert condition indicative of a physical condition of the network cable.

27. The SoC according to claim 26, wherein the monitoring of electrical parameters is passive monitoring.

28. The SoC according to claim 27, wherein the measured electrical parameter is impedance of the monitored line.

29. The SoC according to claim 28, wherein a length of the monitored line is estimated based on the measured impedance.

30. The SoC according to claim 27, wherein the measured electrical parameter is a voltage signal.

31. The SoC according to claim 30, wherein a cable tap is estimated based on the measured voltage signal.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)
